(19) United States
(12) Patent Application Publication
(10) Pub. No.: US 2016/0092747 A1
(43) Pub. Date: Mar. 31, 2016

(54) DEVICES AND METHODS FOR FACILITATING DIGITAL IMAGERY ENCODING BASED ON DETECTION OF TEXT AND COMPUTER GENERATED GRAPHICS

(71) Applicant: QUALCOMM Incorporated, San Diego, CA (US)

(72) Inventors: Mina Ayman Saleh Yanni Makar, San Diego, CA (US); Vijayalakshmi Rajasundaram Raveendran, San Diego, CA (US)

(21) Appl. No.: 14/499,929

(22) Filed: Sep. 29, 2014

(51) Int. Cl. G06K 9/46; H04N 19/124; H04N 19/176; G06K 9/18; G06K 9/52

(52) U.S. Cl. CPC G06K 9/46; G06K 9/18; G06K 9/52; H04N 19/176; H04N 19/124; G06K 2009/4666

(57) ABSTRACT

Methods and electronic devices are adapted to facilitate the detection of text and computer generated graphics in digital imagery for encoding such content in a manner to preserve details. According to one example, an electronic device can mathematically combine pixel values associated with respective pixels from a subgroup of pixels of a digital image according to a plurality of predefined patterns, where each predefined pattern is different from the other predefined patterns. If the result from the mathematical combination is greater than or equal to a predefined threshold, the subgroup of pixels may be determined to include text content and/or computer generated graphic content. On the other hand, if the result from the mathematical combination is less than the predefined threshold, the subgroup of pixels may be determined to not include text content or computer generated graphic content. Other aspects, embodiments, and features are also included.

### TECHNICAL FIELD

The technology discussed below relates generally to wireless communications, and more specifically to methods and devices for facilitating detection of text and computer generated graphics within digital imagery, and the encoding of such imagery based at least in part of such detections.

### BACKGROUND

Digital imagery, as the term is used throughout this disclosure, can include still images and moving images (e.g., digital video). As technology advances, digital imagery is becoming more and more detailed, resulting in increasing numbers of pixels associated with a single still image or video frame, and an increasing number of bits to represent those pixels.

In order to reduce the resources needed to store and/or transmit such digital imagery, digital encoding is often employed. Encoding generally involves operations such as compression, encryption, quantization, etc. Depending on the specific encoding employed, some detail from the data source may be lost. Often, the perceptual quality of encoded digital imagery is affected by the loss of such data. Perceptual quality refers generally to a subjective measure of how clearly the details of the imagery can be visually perceived by viewers. Research on how viewers perceive the data in question may be used to determine what specific data the encoding will allow to be lost. Often, a person viewing encoded digital imagery is more sensitive to the perceptual quality as it applies to certain components of an image than others. For example, it has been determined that viewers are relatively more sensitive to artifacts associated with computer generated graphic components and/or text components than they may be to natural image components.

It may be desirable to provide encoding processes that are capable of detecting text, computer generated graphics, and the like in a manner to enable sufficiently high quality for such content.

### BRIEF SUMMARY OF SOME EXAMPLES

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Various examples and implementations of the present disclosure facilitate low complexity text detection and/or computer generated graphics detection in digital imagery for encoding such digital imagery. According to at least one aspect of the disclosure, electronic devices may be configured for processing digital imagery. In at least one example, an electronic device may include a storage medium including digital imagery stored thereon. A processing circuit may be coupled to the storage medium, and may be adapted to mathematically combine pixel values for each pixel in a group of pixels from the digital imagery according to a plurality of predefined patterns. Each predefined pattern is different from the other predefined patterns and designates whether to add or subtract each pixel value. The processing circuit may be adapted to determine that the group of pixels includes at least one of text or computer generated graphics when the result from the mathematical combination is greater than or equal to a predefined threshold, or that the group of pixels does not include text or computer generated graphics when the result from the mathematical combination is less than the predefined threshold.

Further aspects provide methods operational on access terminals and/or access terminals including means to perform such methods. One or more examples of such methods may include mathematically combining pixel values associated with respective pixels from a macroblock of a digital image according to a plurality of predefined patterns, where each predefined pattern is different from the other predefined patterns. A determination may be made that the macroblock includes content comprising at least one of text or computer generated graphics when the result from the mathematical combination is greater than or equal to a predefined threshold. Further, a determination may be made that the macroblock does not include content comprising at least one of text or computer generated graphics when the result from the mathematical combination is less than the predefined threshold.

Still further aspects include processor-readable storage mediums comprising programming executable by a processing circuit. According to one or more examples, such programming may be adapted for causing the processing circuit to calculate a macroblock value by adding together pixel values for each pixel of a macroblock from a digital image. The pixel values can be added together according to a plurality of predefined patterns designating whether a pixel value is added as a positive or a negative value. The programming may further be adapted for causing the processing circuit to determine that the macroblock includes at least one of text or computer generated graphics when the macroblock value is greater than or equal to a predefined threshold, or to determine that the macroblock does not include text or computer generated graphics when the macroblock value is less than the predefined threshold.

Other aspects, features, and embodiments associated with the present disclosure will become apparent to those of ordinary skill in the art upon reviewing the following description in conjunction with the accompanying figures.

### DRAWINGS

FIG. 1 is a diagram depicting an example of digital imagery.

FIG. 2 is a diagram illustrating an enlarged group of pixels within the digital imagery of FIG. 1.

FIG. 3 is a block diagram illustrating select components of an electronic device according to at least one example of the present disclosure.

FIG. 4 is a block diagram of an example of a 16 pixel×16 pixel macroblock according to at least one example.

FIG. 5, which consists of FIGS. 5A-5B, illustrates several block diagrams depicting several examples of predefined patterns according to at least one implementation.

FIG. 6 is a conceptual block diagram illustrating at least one example of evaluating a macroblock to detect text and/or computer generated graphic content.

FIG. 7 is a conceptual block diagram illustrating an example for computational simplification for evaluating a macroblock to detect text and/or computer generated graphic content.

FIG. 8 is a flow diagram illustrating at least one example of a method operational on an electronic device.

FIG. 9 is a flow diagram depicting at least one example for mathematically combining pixel values for the pixels within a macroblock according to a plurality of predefined patterns.

FIG. 10 is a flow diagram depicting at least one other example for mathematically combining pixel values for the pixels within a macroblock according to a plurality of predefined patterns.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

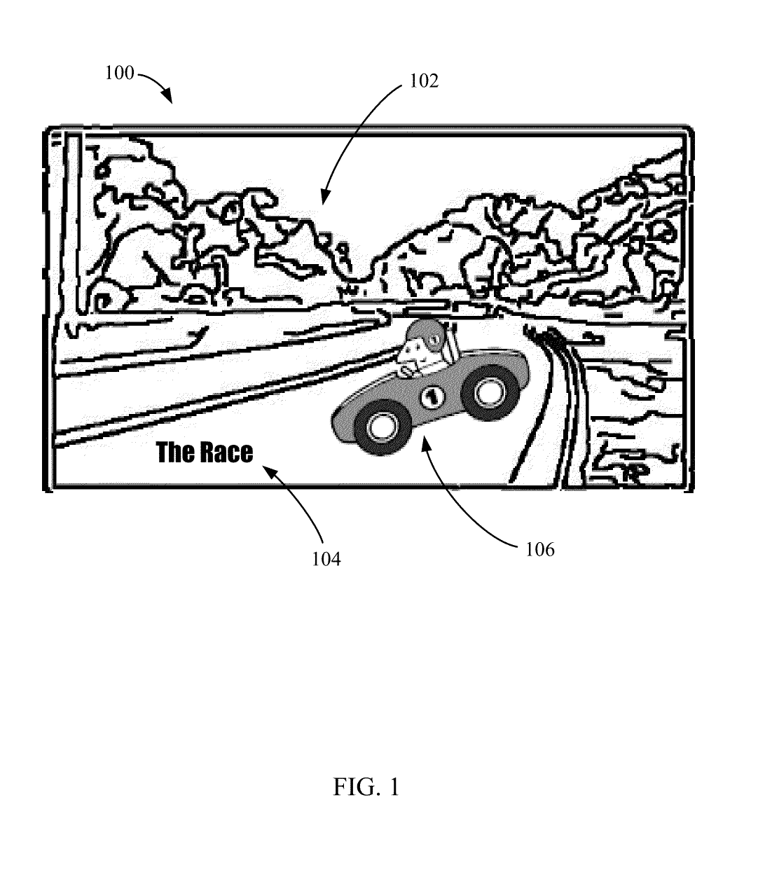

Aspects of the present disclosure relate to text and/or computer generated graphic detection in digital imagery. Referring now to FIG. 1, a digital image 100 may include natural image content, such as the background content 102, text content 104, and/or computer generated graphic content (e.g., the race car and driver 106). The digital image 100 may be a still image, or may be a frame from a digital video.

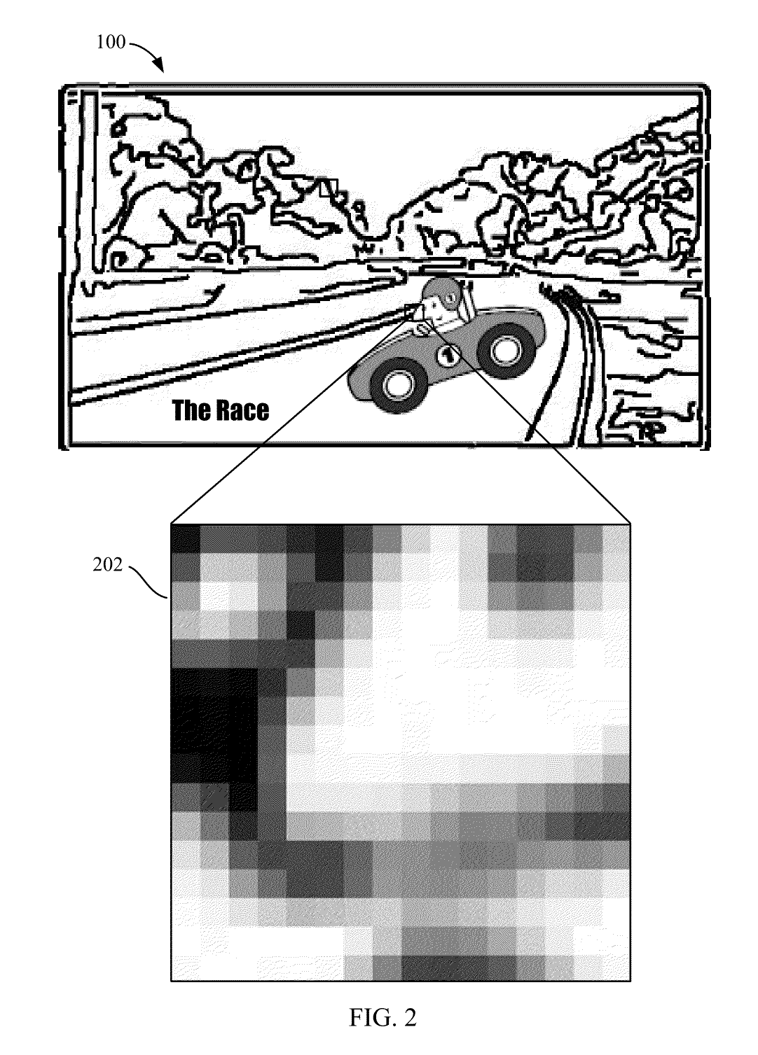

The digital image 100 is typically made up of millions of pixels, each defining a color for the respective location within the image. For example, FIG. 2 illustrates a 16×16 pixel section, which may be referred to as a macroblock 202, from the image 100 in FIG. 1. It should be apparent that although the FIGS. in the present disclosure are shown in black and white or grayscale, each pixel may actually be a particular color. The number of distinct colors that can be represented by a pixel depends on the number of bits per pixel (bpp). For example, with 8 bits per pixel, 256 different colors can be defined, where each pixel is defined by an 8 bit digital number between 0 and 255 that defines intensities for three color components.

According to an aspect of the present disclosure, the text content 104 and the computer generated graphic content 106 in the digital image 100 may be detected. The detection of text content and/or computer generated graphic content can be employed in encoding the digital imagery in a manner to maintain perceptual quality of this content.

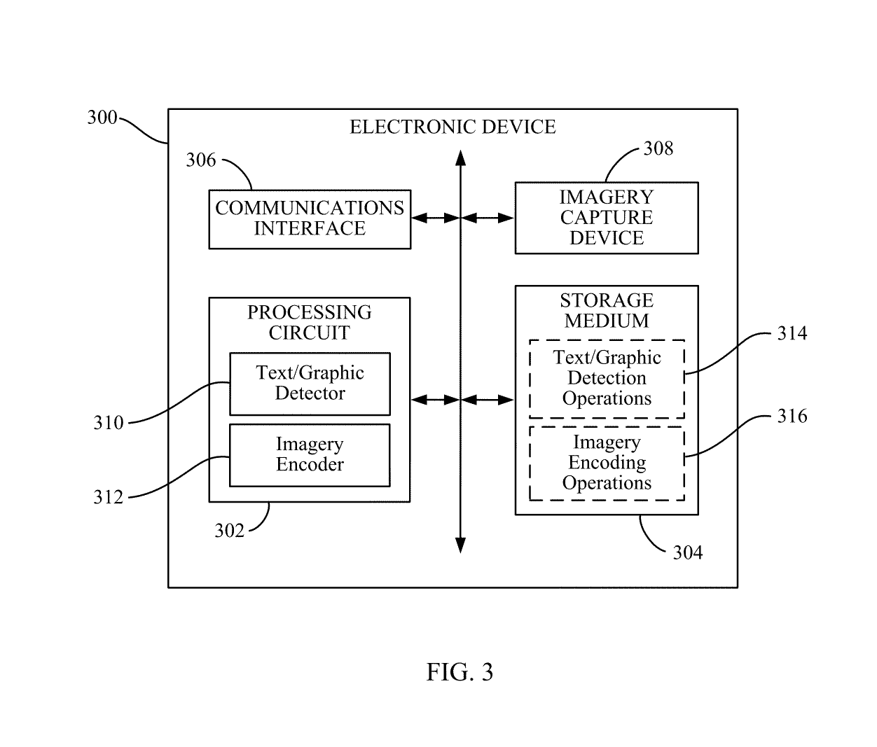

Turning to FIG. 3, a block diagram is shown illustrating select components of an electronic device 300 according to at least one example of the present disclosure. The electronic device 300 includes a processing circuit 302 coupled to or placed in electrical communication with a storage medium 304. The electronic device 300 may also optionally include a communications interface 306 and/or an imagery capture device 308 operatively coupled with the processing circuit 302.

The processing circuit 302 is arranged to obtain, process and/or send data, control data access and storage, issue commands, and control other desired operations. The processing circuit 302 may include circuitry adapted to implement desired programming provided by appropriate media, and/or circuitry adapted to perform one or more functions described in this disclosure. For example, the processing circuit 302 may be implemented as one or more processors, one or more controllers, and/or other structure configured to execute executable programming Examples of the processing circuit 302 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 302 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 302 are for illustration and other suitable configurations within the scope of the present disclosure are also contemplated.

The processing circuit 302 is adapted for processing, including the execution of programming, which may be stored on the storage medium 306. As used herein, the term “programming” shall be construed broadly to include without limitation instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

In some instances, the processing circuit 302 may include a text/graphic detector 310 and an imagery encoder 312. The text/graphic detector 310 may include circuitry and/or programming (e.g., programming stored on the storage medium 304) adapted to detect text content and computer generated graphical content within imagery. The imagery decoder 312 may include circuitry and/or programming (e.g., programming stored on the storage medium 304) adapted to employ information relating to detected text and/or computer generated graphics to encode imagery according to one or more digital imagery encoding algorithms.

The storage medium 304 may represent one or more processor-readable devices for storing programming, such as processor executable code or instructions (e.g., software, firmware), electronic data, databases, or other digital information. The storage medium 304 may also be used for storing data that is manipulated by the processing circuit 304 when executing programming The storage medium 304 may be any available media that can be accessed by a general purpose or special purpose processor, including portable or fixed storage devices, optical storage devices, and various other mediums capable of storing, containing and/or carrying programming By way of example and not limitation, the storage medium 304 may include a processor-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof

The storage medium 304 may be coupled to the processing circuit 302 such that the processing circuit 302 can read information from, and write information to, the storage medium 304. That is, the storage medium 304 can be coupled to the processing circuit 302 so that the storage medium 304 is at least accessible by the processing circuit 302, including examples where the storage medium 304 is integral to the processing circuit 302 and/or examples where the storage medium 304 is separate from the processing circuit 302 (e.g., resident in the electronic device 300, external to the electronic device 300, distributed across multiple entities).

Programming stored by the storage medium 304, when executed by the processing circuit 302, causes the processing circuit 302 to perform one or more of the various functions and/or process steps described herein. In at least some examples, the storage medium 304 may include text/graphic detection operations 314 and imagery encoding operations 316. The text/graphic detection operations 314 are adapted to cause the processing circuit 302 to detect text content and computer generated graphical content within imagery, as described herein. The imagery encoding operations 316 are adapted to cause the processing circuit 302 to encode imagery according to one or more digital imagery encoding algorithms and in response to the information relating to any detected text and/or computer generated graphics.

Thus, according to one or more aspects of the present disclosure, the processing circuit 302 is adapted to perform (in conjunction with the storage medium 304) any or all of the processes, functions, steps and/or routines for any or all of the electronic devices described herein. As used herein, the term “adapted” in relation to the processing circuit 302 may refer to the processing circuit 302 being one or more of configured, employed, implemented, and/or programmed (in conjunction with the storage medium 304) to perform a particular process, function, step and/or routine according to various features described herein.

The communications interface 306 is configured to facilitate wireless and/or wired communications of the electronic device 300. For example, the communications interface 306 may include circuitry and/or programming adapted to facilitate the communication of information bi-directionally with respect to one or more other devices.

The imagery capture device 308 is configured to facilitate the capture and digitization of imagery. The imagery capture device 308 may include a camera and related hardware and programming capable of obtaining still and/or video imagery, as is generally known to those of ordinary skill in the art.

In operation, the electronic device 300 is adapted to analyze digital imagery data to detect text and/or computer generated graphics using relatively low complexity operations. In general, the electronic device 300 is adapted to evaluate a group of pixels (e.g., a 16×16 macroblock) of the digital imagery by mathematically combining the value of each pixel within the group according to a predefined pattern. For example, the electronic device 300 may combine the numeric value for each pixel in a group by either addition or subtraction, depending on the location of the pixel within the group of pixels. In some embodiments, a plurality of predefined patterns may be used on each group of pixels, and the results from each of the patterns may be combined to obtain a total value. Based on the resulting value, the electronic device 300 can predict whether the group of pixels includes text and/or computer generated graphic components.

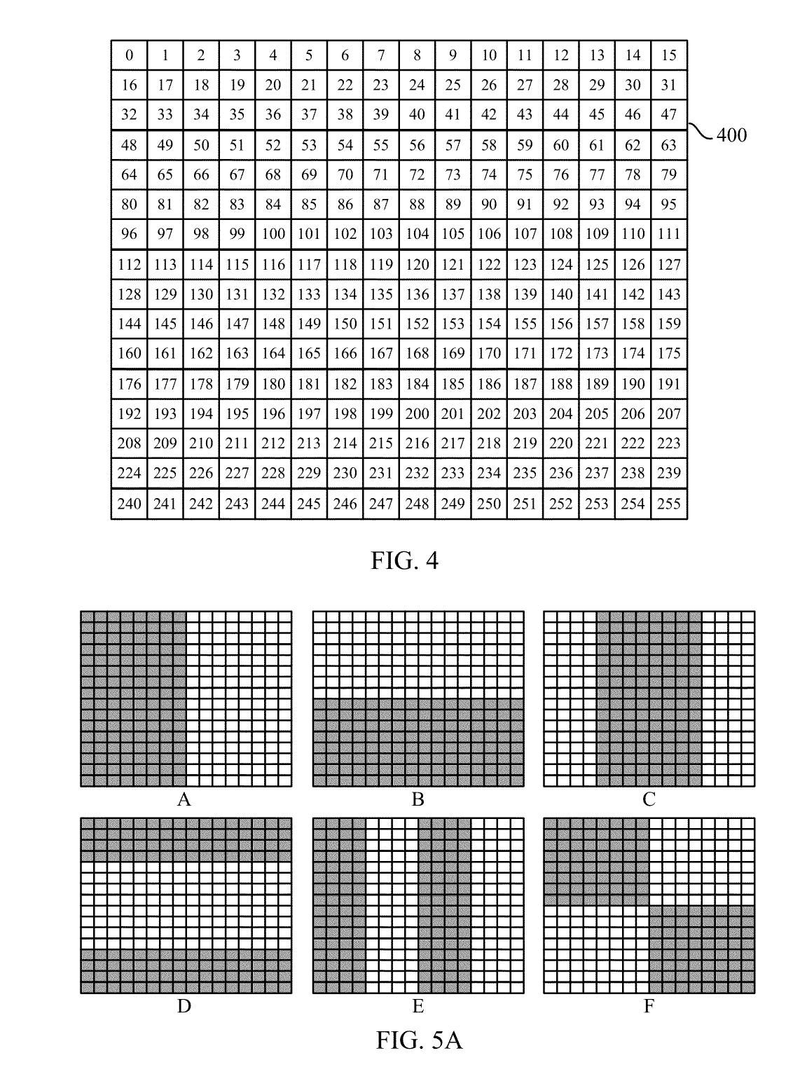

A more specific example will be described. FIG. 4 is a block diagram of an example of a 16×16 macroblock 400 where each square represents one pixel. In the block diagram each pixel is numbered consecutively from 0 to 255. In digital imagery, each of the pixels 0-255 within the macroblock is defined by a numerical value, which specifies the color of the particular pixel. Thus, each pixel 0-255 in the macroblock 400 will have a numerical value associated with it. This numerical value is referred to herein as a “pixel value.” The electronic device 300 can add or subtract each pixel value within the macroblock 400 to obtain a total value (or SUM) for the macroblock, where the total value may indicate whether the macroblock contains text and/or computer generated graphics.

According to an aspect of the present disclosure, each of the different patterns may be adapted to determine whether a pixel will be added to the total or whether it will be subtracted from the total when the pixel values are all mathematically combined. Another way of thinking about it is that the patterns can indicate whether a pixel value will be positive or negative.

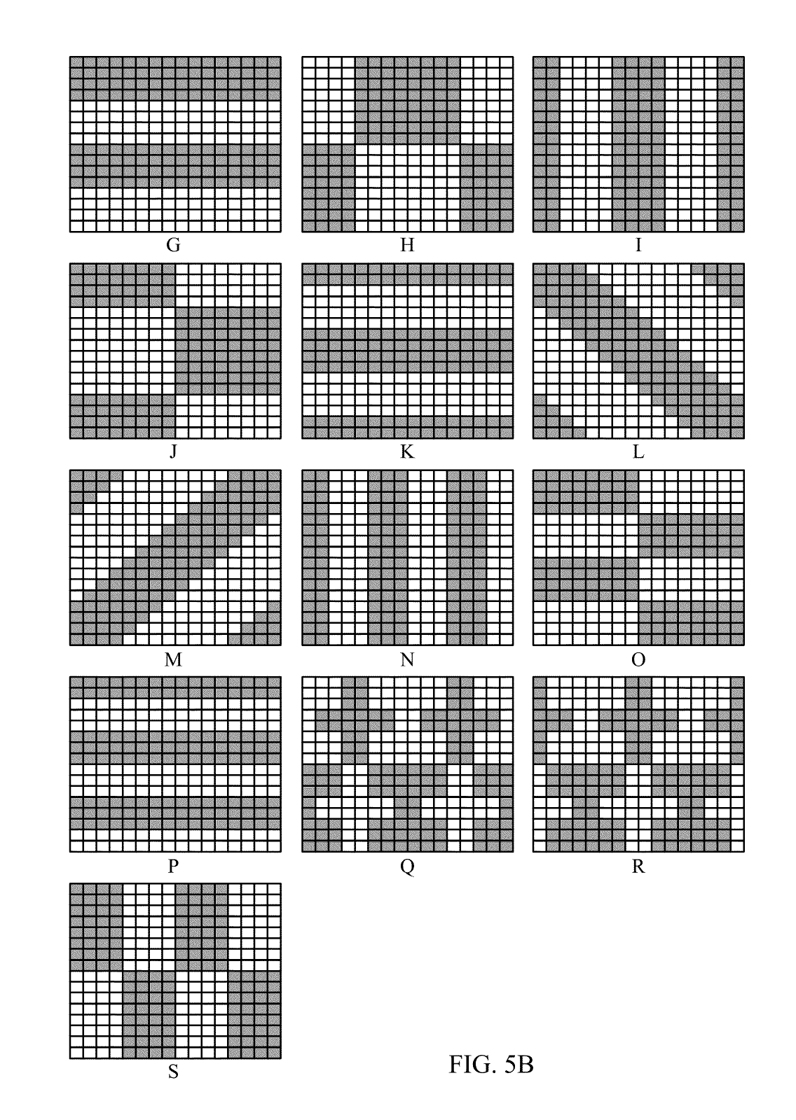

In FIG. 5, made up of FIGS. 5A-5B, a number of examples of patterns are shown. In the depicted examples, the shaded pixels represent the areas where the pixel values are subtracted (e.g., added with a negative value) and the unshaded (e.g., white) areas represent those areas where the pixel values are added (e.g., added with a positive value). For instance, applying the top-left pattern labeled ‘A’ in FIG. 5A to the macroblock 400 in FIG. 4 will result in the pixel values for pixels 0-7, 16-23, 32-39, 48-55, 64-71, etc. being subtracted (e.g., added with a negative value) and pixels 8-15, 24-31, 40-47, 56-63, 72-79, etc. being added (e.g., added with a positive value) to obtain a total value (or SUM) for the macroblock. When applying the pattern labeled ‘B’ in FIG. 5A to the macroblock 400 in FIG. 4, the pixel values for the pixels located at positions 0-127 are added and the pixel values for pixels, and the pixel values for the pixels located at positioned 128-255 are subtracted to obtain the total value (or SUM) for the macroblock. This mathematical combination may be repeated for each of the different patterns to obtain several different total values (or SUMs) for the macroblock. It should be understood that the depicted patterns are just some examples that may be employed, and various implementations may employ all, some, and/or different patterns.

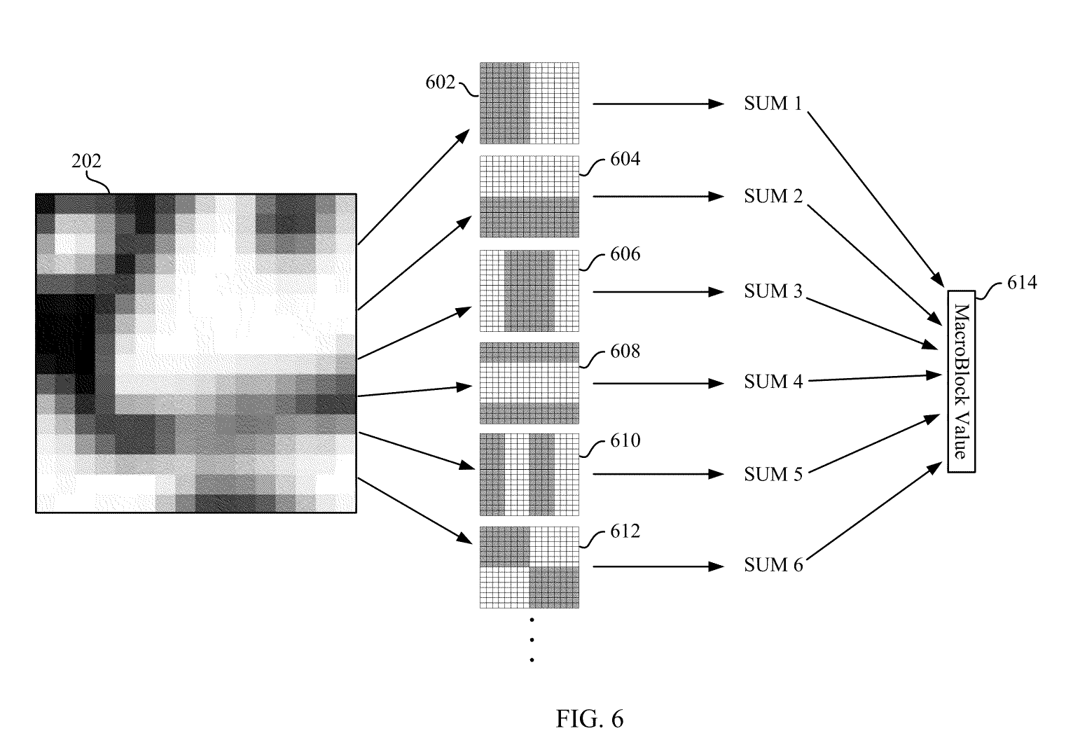

Turning to FIG. 6, a block diagram is shown illustrating the macroblock 202 from FIG. 2 being evaluated by the text/graphic detector 310 of the electronic device 300. The electronic device 300 may obtain the digital image 100 in any known manner. For instance, the electronic device 300 may capture the digital image 100 using the imagery capture device 308, may receive the image 100 in a transmission via the communications interface, may access the image 100 as it is stored in the storage medium 304, or any other means that are common and generally known to those of ordinary skill in the art. Within the digital image 100 are a number of macroblocks consisting of a group of pixels. In this example, each macroblock includes 16×16 pixels.

Each macroblock can be analyzed independently by the electronic device 300. In one example, the text/graphic detector 310 can initially add up the pixel values for each pixel within the macroblock according to the top pattern 602 to obtain SUM 1. In some examples, the pixel values associated with the shaded regions in the pattern 602 can be multiplied by a negative one (−1) and then all of the pixel values can be added together to obtain the value of SUM 1. In other examples, the pixel values associated with the shaded regions in the pattern 602 can be subtracted from the total, while the pixel values associated with the white regions in the pattern 602 can be added to the total to obtain SUM 1. The resulting value for SUM 1 may be an absolute value of the resulting sum from adding/subtracting each of the pixel values according to the predefined pattern so that SUM 1 is not a negative value.

Similarly, the text/graphic detector 310 can apply other patterns, such as patterns 604, 606, 608, 610, 612, etc. to obtain respective SUM 2, SUM 3, SUM 4, SUM 5, SUM 6, etc. In some examples, all of the patterns ‘A’-‘S’ in FIGS. 5A and 5B may be applied to each macroblock of the digital imagery. In other examples, only a subset of patterns in FIGS. 5A and 5B may be applied. In still other examples, additional and/or different patterns may be applied.

Once all of the total values (SUMs) are obtained for each predefined pattern, those total values can be added together to obtain the total value for the macroblock, identified as MacroBlock value 614. The text/graphic detector 310 then compares the MacroBlock value 614 to a predefined threshold. If the MacroBlock value 614 is greater than or equal to the predefined threshold, then the text/graphic detector 310 can determine that the macroblock 202 includes text and/or computer generated graphics content. If the MacroBlock value 614 is below the predefined threshold, then the text/graphic detector 310 can determine that the macroblock 202 does not include text and/or computer generated graphics content.

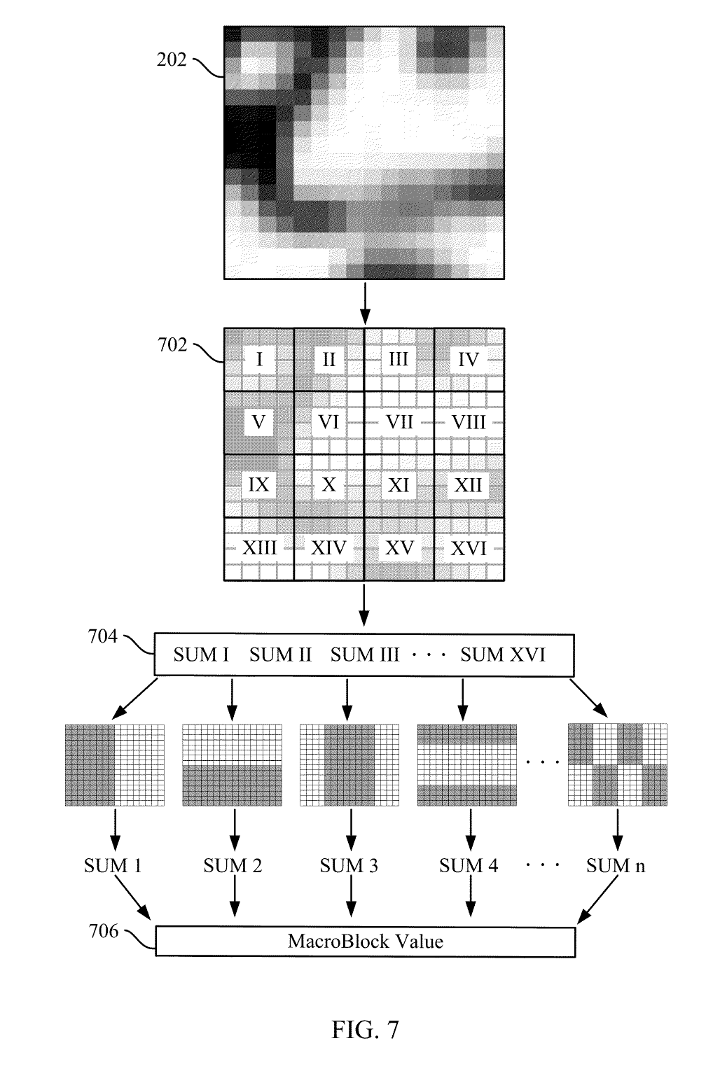

In some implementations, the electronic device 300 may employ features to further reduce the number of computations for obtaining a MacroBlock value. For instance, the text/graphic detector 310 may calculate values for a smaller portion of the macroblock, and then use those values for calculations in all of the different patterns. FIG. 7 illustrates a conceptual block diagram illustrating an example for such computational simplification for evaluating a macroblock to detect text and/or computer generated graphic content. In this example, the 16×16 macroblock 202 is divided into 16 smaller groups of pixels, where each group is a 4×4 block of 16 pixels from the macroblock 202. As shown, the 16 different groups are labeled I, II, III, IV, V, VI, VII, VIII, IX, X, XI, XII, XIII, XIV, XV, and XVI.

To calculate a MacroBlock value in this example, the macroblock 202 can first be divided into the smaller groups of pixels I-XVI as depicted at 702. The text/graphic detector 310 can then calculate a group value for each group I-XVI by adding the pixel values for each pixel within each group I-XVI to obtain a respective value. The group values for each respective group I-XVI are depicted as SUM I, SUM II, etc. in box 704.

Instead of adding or subtracting each pixel value according to the various patterns, the text/graphic detector 310 can add or subtract each group according to the various patterns. To facilitate such pixel groupings, the text/graphic detector 310 can apply patterns where the pixels within a group are either all added or all subtracted. For instance, in the example in FIG. 7, the groups I-XVI are formed from 4×4 blocks of the macroblock. Considering the patterns in FIGS. 5A and 5B, it will be apparent that patterns ‘A’-‘H’, ‘J’, ‘O’, and ‘S’ are each configured so that all of the pixels within each group I-XVI are combined in the same way. That is, all of the pixels in each of the groups I-XVI are either all added or all subtracted no matter which pattern ‘A’, ‘B’, ‘C’, ‘D’, ‘E’, ‘F’, ‘G’, ‘H’, ‘J’, ‘O’, or ‘S’ is applied. Thus, instead of calculating a value for each pattern by adding or subtracting each pixel, the text/graphic detector 310 can more simply calculate a value for each pattern by adding or subtracting the group value according to the respective pattern. It is noted that more, fewer, and/or different patterns may be used in different implementations.

To further illustrate this feature, the first depicted pattern in FIG. 7 corresponds to pattern A in FIG. 5A. When applying this pattern A to the macroblock 202, the text/graphic detector 310 can add the group value for each of the group values identified by SUMs III, IV, VII, VIII, XI, XII, XV, and XVI, and can subtract the group value of each of the group values identified by SUMs I, II, V, VI, IX, X, XIII, and XIV to obtain a total value for the pattern, as indicated by SUM 1. Each of the remaining patterns can also be applied to the macroblock 202 in a similar manner, such that the group sums are employed instead of performing a calculation for each pixel.

Similar to the example described above with reference to FIG. 6, a total MacroBlock value 706 can be obtained by adding together all of the SUMs (e.g., SUM 1-SUM n). As set forth above, the text/graphic detector 310 then compares the MacroBlock value 706 to a predefined threshold. If the MacroBlock value 706 is greater than or equal to the predefined threshold, then the text/graphic detector 310 can determine that the macroblock 202 includes text and/or computer generated graphics content. If the MacroBlock value 706 is below the predefined threshold, then the text/graphic detector 310 can determine that the macroblock 202 does not include text and/or computer generated graphics content.

In response to a determination by the text/graphic detector 310 that a macroblock contains text and/or computer generated graphics content, the imagery encoder 312 can encode the macroblock in a manner to better preserve the details (e.g., employ a low quantization parameter). The specific imagery encoding algorithm employed may vary according to applications. By way of example and not limitation, the imagery encoding 312 may employ JPEG image coding standard, H.264, HEVC video coding standards, or any other known encoding algorithm.

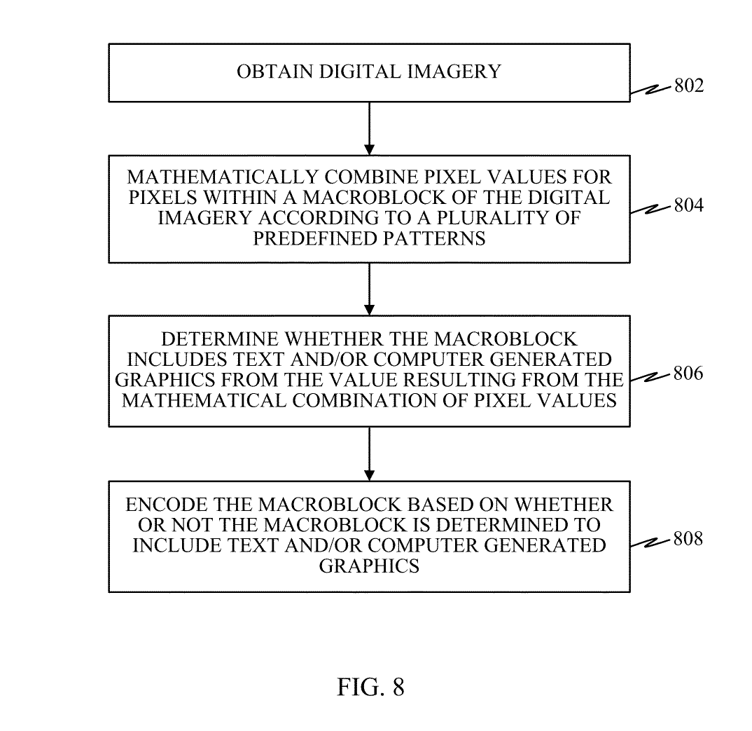

Various aspects of the present disclosure relate to methods operational on an electronic device for encoding digital imagery. Turning to FIG. 8, a flow diagram is depicted illustrating at least one example of such a method operational on an electronic device, such as the electronic device 300. Referring to FIGS. 3 and 8, an electronic device 300 may initially obtain digital imagery, at 802. For example, the processing circuit 302 may obtain the digital imagery. In some examples, the processing circuit 302 may capture the digital imagery as either still pictures or video via the imagery capture device 308. In such cases the captured imagery may be stored by the storage medium 304. In other examples, the processing circuit 302 may obtain imagery that has been previously stored on the storage medium 304. In still other examples, the processing circuit 302 may receive digital imagery transmitted via the communications interface 306. In such examples, the digital imagery may also be stored by the storage medium 304 on receipt.

In order to determine the degree to which details within portions of the digital imagery is to be preserved, the electronic device 300 may determine whether the imagery includes any text or computer generated graphics. At 804, the electronic device 300 may analyze each macroblock for text and/or computer generated graphics by mathematically combining pixel values for the pixels within a macroblock according to a plurality of predefined patterns. For example, the processing circuit 302 (e.g., the text/graphic detector 310) executing the text/graphic detection operations 314 may mathematically combine pixel values for each pixel of a macroblock according to a plurality of predefined patterns.

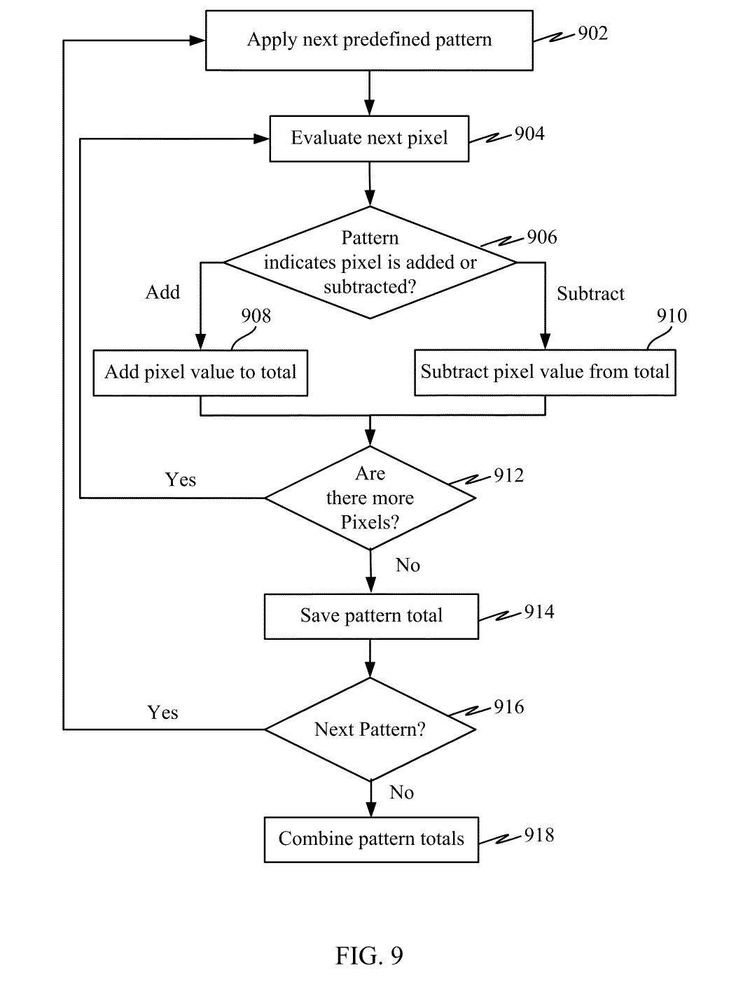

Referring to FIG. 9, a flow diagram is shown depicting at least one example for mathematically combining pixel values for the pixels within a macroblock according to a plurality of predefined patterns referred to in step 804 of the process depicted in FIG. 8. At operation 902, the processing circuit 302 (e.g., the text/graphic detector 310) executing the text/graphic detection operations 314 may apply a first predefined pattern (e.g., pattern A in FIG. 5A), where the pattern indicates whether to add or subtract the pixel value associated with each respective pixel in the macroblock according to the location of the pixel. For instance, the pattern A in FIG. 5A designates the pixels in the left half as having their respective pixel values subtracted from the other pixels values, and the pixels in the right half as having their respective pixel values added to the other pixel values of the macroblock.

The processing circuit 302 (e.g., the text/graphic detector 310) executing the text/graphic detection operations 314 then mathematically combines each of the pixel values by adding or subtracting the pixel values for each pixel of the macroblock according to this first predefined pattern. For instance, at operation 904, the next pixel (e.g., initial pixel if starting) is evaluated. At decision diamond 906, processing circuit 302 (e.g., the text/graphic detector 310) executing the text/graphic detection operations 314 determines whether the pattern indicates the pixel is to be added or subtracted.

If the pattern indicates the pixel is to be added, then it is added to a total at operation 908. On the other hand, if the pattern indicates the pixel is to be subtracted, then it is subtracted from the total at operation 910. The initial total will start at 0, and each pixel value is combined as defined by the pattern.

At decision diamond 912, a determination is made whether there are further pixels in the macroblock. If yes, then the process returns to operation 904, where the next pixel is evaluated. If no, then the process continues to operation 914 where the total is saved. As noted above, the saved pattern total may be an absolute value of the calculated sum, to ensure it is a positive value.

After the total value of the predefined pattern is saved for the macroblock, a determination is made whether there is another pattern at decision diamond 916. If so, the process returns to operation 902 and applies the next pattern. If not, then the saved pattern total values for all of the evaluated patterns are combined at operation 918 to obtain a macroblock value (e.g., macroblock value 614 in FIG. 6).

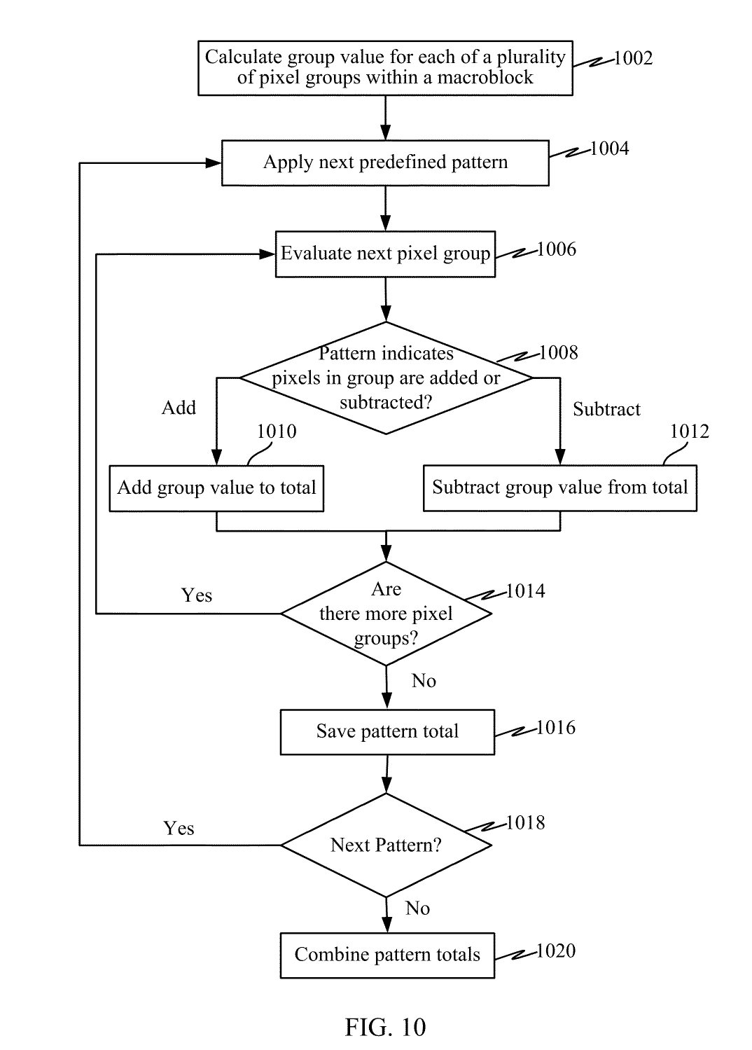

Referring to FIG. 10, a flow diagram is shown depicting at least one other example for mathematically combining pixel values for the pixels within a macroblock according to a plurality of predefined patterns referred to in step 804 of the process depicted in FIG. 8. At operation 1002, the processing circuit 302 (e.g., the text/graphic detector 310) executing the text/graphic detection operations 314 may calculate a group value for each of a plurality of pixel groups within a macroblock. For instance, as described above with reference to FIG. 7, a macroblock is divided into smaller groups of pixels, and a group value is calculated by adding the pixel values for each pixel associated with a respective group.

At operation 1004, the processing circuit 302 (e.g., the text/graphic detector 310) executing the text/graphic detection operations 314 may apply a first predefined pattern (e.g., pattern A in FIG. 5A), where the pattern indicates whether to add or subtract the pixel value associated with each respective pixel in the macroblock according to the location of the pixel. For instance, the pattern A in FIG. 5A designates the pixels in the left half as having their respective pixel values subtracted from the other pixels values, and the pixels in the right half as having their respective pixel values added to the other pixel values of the macroblock.

The processing circuit 302 (e.g., the text/graphic detector 310) executing the text/graphic detection operations 314 then mathematically combines each of the pixel values by adding or subtracting the group values for each pixel group of the macroblock according to this first predefined pattern. For instance, at operation 1006, the next pixel group (e.g., initial pixel group if starting) is evaluated. At decision diamond 1008, processing circuit 302 (e.g., the text/graphic detector 310) executing the text/graphic detection operations 314 determines whether the pattern indicates that the pixels in the pixel group are to be added or subtracted.

If the pattern indicates the pixels in the pixel group are to be added, then the group value associated with the pixel group is added to a total at operation 1010. On the other hand, if the pattern indicates the pixels in pixel group are to be subtracted, then the group value is subtracted from the total at operation 1012. The initial total will start at 0, and each group value is combined as defined by the pattern.

At decision diamond 1014, a determination is made whether there are further pixel groups in the macroblock. If yes, then the process returns to operation 1006, where the next pixel group is evaluated. If no, then the process continues to operation 1016 where the total is saved. As noted above, the saved pattern total may be an absolute value of the calculated sum, to ensure it is a positive value.

After the total value of the predefined pattern is saved for the macroblock, a determination is made whether there is another pattern at decision diamond 1018. If so, the process returns to operation 1004 and applies the next pattern. If not, then the saved pattern total values for all of the evaluated patterns are combined at operation 1020 to obtain a macroblock value (e.g., macroblock value 706 in FIG. 7).

Returning to FIG. 8, the electronic device 300 can determine whether that the macroblock includes text or computer generated graphics based on the value resulting from the mathematical combination of the pixel values for the macroblock at 806. For example, the processing circuit 302 (e.g., the text/graphic detector 310) executing the text/graphic detection operations 314 may compare the number value resulting from the mathematical combination of the pixel values in the macroblock (e.g., macroblock value 614 in FIG. 6, macroblock value 706 in FIG. 7) to determine if the value is greater than or equal to a predefined threshold. If the value is greater than or equal to the predefined threshold, the processing circuit 302 (e.g., the text/graphic detector 310) executing the text/graphic detection operations 314 may determine that the macroblock includes text and/or computer generated graphic content. If the value is less than the predefined threshold, the processing circuit 302 (e.g., the text/graphic detector 310) executing the text/graphic detection operations 314 may determine that the macroblock does not include text and/or computer generated graphic content.

At 808, the electronic device 300 can encode the macroblock based at least in part on whether the macroblock has been determined to include text and/or computer generated graphic content. For example, the processing circuit 302 (e.g., the imagery encoder 312) executing the imagery encoding operations 316 may encode the macroblock. If the mathematical combination for the macroblock is greater than or equal to the predefined threshold, the processing circuit 302 (e.g., the imagery encoder 312) executing the imagery encoding operations 316 may encode the macroblock in a manner to preserve details within the macroblock (e.g., employ a lower quantization parameter compared to the quantization parameter that would be employed when the mathematical combination is less than the predefined threshold). If the mathematical combination for the macroblock is less than the predefined threshold, the processing circuit 302 (e.g., the imagery encoder 312) executing the imagery encoding operations 316 may encode the macroblock without regard for text and/or computer generated graphics (e.g., employ a higher quantization parameter compared to the quantization parameter that would be employed when the mathematical combination is greater than or equal to the predefined threshold).

While the above discussed aspects, arrangements, and embodiments are discussed with specific details and particularity, one or more of the components, steps, features and/or functions illustrated in FIGS. 1, 2, 3, 4, 5, 6, 7, 8, and/or 9 may be rearranged and/or combined into a single component, step, feature or function or embodied in several components, steps, or functions. Additional elements, components, steps, and/or functions may also be added or not utilized without departing from the present disclosure. The apparatus, devices and/or components illustrated in FIG. 3 may be configured to perform or employ one or more of the methods, features, parameters, and/or steps described in FIGS. 1, 2, 4, 5, 6, 7, 8, and/or 9. The novel algorithms described herein may also be efficiently implemented in software and/or embedded in hardware.

While features of the present disclosure may have been discussed relative to certain embodiments and figures, all embodiments of the present disclosure can include one or more of the advantageous features discussed herein. In other words, while one or more embodiments may have been discussed as having certain advantageous features, one or more of such features may also be used in accordance with any of the various embodiments discussed herein. In similar fashion, while exemplary embodiments may have been discussed herein as device, system, or method embodiments, it should be understood that such exemplary embodiments can be implemented in various devices, systems, and methods.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. The various methods described herein may be partially or fully implemented by programming (e.g., instructions and/or data) that may be stored in a processor-readable storage medium, and executed by one or more processors, machines and/or devices.

Those of skill in the art would further appreciate that the various illustrative logical blocks, modules, circuits, and algorithm steps described in connection with the embodiments disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is only determined by the literal language, and legal equivalents, of the claims which follow.

What is claimed is:

1. A method operational on an electronic device including the detection of text and computer generate graphics in digital imagery, comprising:
mathematically combining pixel values associated with respective pixels from a macroblock of a digital image according to a plurality of predefined patterns, wherein each predefined pattern is different from the other predefined patterns;
determining that the macroblock includes content comprising at least one of text or computer generated graphics when the result from the mathematical combination is greater than or equal to a predefined threshold; and
determining that the macroblock does not include content comprising at least one of text or computer generated graphics when the result from the mathematical combination is less than the predefined threshold.

2. The method of claim 1, wherein mathematically combining the pixel values associated with respective pixels from the macroblock of the digital image according to the plurality of predefined patterns comprises:
applying a first predefined pattern to the pixels of the macroblock, wherein the first predefined pattern indicates whether to add or subtract the pixel value associated with each respective pixel according to a location of the pixel in the macroblock;
adding or subtracting the pixel values for each pixel of the macroblock according to the first predefined pattern;
applying one or more additional predefined patterns to the pixels of the macroblock, wherein each of the one or more additional predefined patterns employs a different pattern for indicating whether to add or subtract the pixel value associated with each respective pixel; and
adding or subtracting the pixel values for each pixel of the macroblock according to each of the one or more additional predefined patterns.

3. The method of claim 2, wherein:
adding or subtracting the pixel values for each pixel of the macroblock according to the first predefined pattern comprises adding or subtracting a respective group value for each of a plurality of pixel groups of the macroblock according to the first predefined pattern; and
adding or subtracting the pixel values for each pixel of the macroblock according to each of the one or more additional predefined patterns comprises adding or subtracting the respective group value for each of the plurality of pixel groups of the macroblock according to each of the one or more additional predefined patterns.

4. The method of claim 2, wherein mathematically combining the pixel values associated with respective pixels from the macroblock of the digital image according to the plurality of predefined patterns further comprises:
adding the resulting values from each of the first predefined pattern and the one or more additional predefined patterns to obtain a macroblock value.

5. The method of claim 4, wherein determining that the macroblock includes or does not include content comprising at least one of text or computer generated graphics comprises:
determining that the macroblock includes content comprising at least one of text or computer generated graphics when the macroblock value is greater than or equal to the predefined threshold; and
determining that the macroblock does not include content comprising at least one of text or computer generated graphics when the macroblock value is less than the predefined threshold.

6. The method of claim 1, further comprising:
encoding the macroblock to preserve details in the macroblock in response to determining that the mathematical combination is greater than or equal to the predefined threshold.

7. The method of claim 6, wherein encoding the macroblock to preserve details in the macroblock in response to determining that the mathematical combination is greater than or equal to the predefined threshold comprises:
employing a lower quantization parameter compared to a quantization parameter employed when the mathematical combination is less than the predefined threshold.

8. The method of claim 1, wherein the macroblock is 16 pixels by 16 pixels in size.

9. An electronic device for processing digital imagery, comprising:
a storage medium comprising digital imagery; and
a processing circuit coupled to the storage medium, the processing circuit adapted to:
mathematically combine pixel values for each pixel in a group of pixels from the digital imagery according to a plurality of predefined patterns, wherein each predefined pattern is different from the other predefined patterns and designates whether to add or subtract each pixel value;
determine that the group of pixels includes at least one of text or computer generated graphics when the result from the mathematical combination is greater than or equal to a predefined threshold; and
determine that the group of pixels does not include text or computer generated graphics when the result from the mathematical combination is less than the predefined threshold.

10. The electronic device of claim 9, wherein the processing circuit adapted to mathematically combine pixel values for each pixel in the group of pixels according to the plurality of predefined patterns comprises the processing circuit adapted to:
apply a first predefined pattern to the group of pixels, wherein the first predefined pattern indicates whether to add or subtract the pixel value associated with each respective pixel according to a location of the pixel within the group of pixels;
add or subtract the pixel values for each pixel according to the first predefined pattern to obtain a respective total for the first predefined pattern;
apply at least one other predefined pattern to the group of pixels, wherein the at least one other predefined pattern employs a different pattern for indicating whether to add or subtract the pixel value associated with each respective pixel;
add or subtract the pixel values for each pixel according to the at least one other predefined pattern to obtain a respective total for the at least one other predefined pattern; and
combine the respective totals for the first predefined pattern and for the at least one other predefined pattern to obtain a total macroblock value.

11. The electronic device of claim 10, wherein:
the processing circuit adapted to add or subtract the pixel values for each pixel according to the first predefined pattern comprises the processing circuit adapted to: add or subtract a respective group value for each of a plurality of smaller pixel groups of the group of pixels according to the first predefined pattern; and
the processing circuit adapted to add or subtract the pixel values for each pixel according to the at least one other predefined pattern comprises the processing circuit adapted to: add or subtract the respective group value for each of the plurality of smaller pixel groups of the group of pixels according to the at least one other predefined pattern.

12. The electronic device of claim 10, wherein the processing circuit is adapted to:
determine that the group of pixels includes at least one of text or computer generated graphics when the total macroblock value is greater than or equal to the predefined threshold; and
determine that the group of pixels does not include text or computer generated graphics when the total macroblock value is less than the predefined threshold.

13. The electronic device of claim 9, wherein the processing circuit is further adapted to:
in response to a determination that the mathematical combination is greater than or equal to the predefined threshold, encode the macroblock utilizing a lower quantization parameter compared to a quantization parameter employed when the mathematical combination is less than the predefined threshold.

14. The electronic device of claim 9, further comprising an imagery capture device operatively coupled to the processing circuit, wherein the processing circuit is further adapted to obtain the digital imagery via the imagery capture device.

15. An access terminal, comprising:
means for mathematically combining pixel values for each pixel of a group of pixels from a digital image according to a plurality of predefined patterns, wherein each predefined pattern designates whether a pixel value is combined as a positive or negative value;
means for determining that the macroblock includes content comprising at least one of text or computer generated graphics when the result from the mathematical combination is greater than or equal to a predefined threshold; and
means for determining that the macroblock does not include content comprising at least one of text or computer generated graphics when the result from the mathematical combination is less than the predefined threshold.

16. The access terminal of claim 15, wherein the means for mathematically combining the pixel values for each pixel of the group of pixels of the digital image according to the plurality of predefined patterns comprises:
means for applying a first predefined pattern to the group of pixels, wherein the first predefined pattern indicates whether each pixel value is combined as a positive or negative pixel value based on a location of the pixel;
means for adding the pixel values for each pixel of the macroblock according to the first predefined pattern to obtain a respective total value associated with the first predefined pattern;
means for applying one or more additional predefined patterns to the group of pixels, wherein each of the one or more additional predefined patterns employs a different pattern for indicating whether each pixel value is combined as a positive or negative pixel value; and
means for adding the pixel values for each pixel of the macroblock according to each of the one or more additional predefined patterns to obtain a respective total value associated with each of the one or more additional predefined patterns.

17. The access terminal of claim 16, wherein:
the means for adding the pixel values for each pixel of the macroblock according to the first predefined pattern comprises means for adding a respective group value for each of a plurality of pixel groups of the macroblock according to the first predefined pattern; and
the means for adding the pixel values for each pixel of the macroblock according to each of the one or more additional predefined patterns comprises means for adding the respective group value for each of the plurality of pixel groups of the macroblock according to each of the one or more additional predefined patterns.

18. The access terminal of claim 16, wherein the means for mathematically combining the pixel values for each pixel of the group of pixels of the digital image according to the plurality of predefined patterns further comprises:
means for adding the total value associated with the first predefined pattern with the total value associated with each of the one or more additional predefined patterns to obtain a macroblock value.

19. The access terminal of claim 15, further comprising:
means for encoding the macroblock utilizing a lower quantization parameter compared to a quantization parameter employed when the mathematical combination is less than the predefined threshold, in response to a determination that the mathematical combination is greater than or equal to the predefined threshold.

20. The access terminal of claim 15, further comprising means for obtaining the digital image.

21. A processor-readable storage medium storing processor-executable programming for causing a processing circuit to:
calculate a macroblock value by adding together pixel values for each pixel of a macroblock from a digital image, wherein the pixel values are added together according to a plurality of predefined patterns designating whether a pixel value is added as a positive or a negative value;
determine that the macroblock includes at least one of text or computer generated graphics when the macroblock value is greater than or equal to a predefined threshold; and
determine that the macroblock does not include text or computer generated graphics when the macroblock value is less than the predefined threshold.

22. The processor-readable storage medium of claim 21, wherein the processor-executable programming for causing a processing circuit to calculate the macroblock value by adding together pixel values for each pixel of a macroblock from a digital image comprises processor-executable programming for causing a processing circuit to:
apply a first predefined pattern to the pixels of the macroblock, wherein the first predefined pattern indicates whether each pixel value is added as a positive or a negative value based on a location of the pixel in the macroblock;
add the pixel values for each pixel of the macroblock according to the first predefined pattern to obtain a respective total for the first predefined pattern;
apply one or more additional predefined patterns to the pixels of the macroblock, wherein each of the one or more additional predefined patterns employs a different pattern for indicating whether each pixel value is added as a positive or a negative value;
add the pixel values for each pixel of the macroblock according to each of the one or more additional predefined patterns to obtain a respective total for each of the one or more additional predefined patterns; and
add the absolute value of the respective total for the first predefined pattern with the absolute value of the respective total for each of the one or more additional predefined patterns to obtain the macroblock value.

23. The processor-readable storage medium of claim 22, wherein:
the processor-executable programming for causing a processing circuit to add the pixel values for each pixel of the macroblock according to the first predefined pattern comprises processor-executable programming for causing a processing circuit to add a respective group value for each of a plurality of pixel groups of the macroblock according to the first predefined pattern; and
the processor-executable programming for causing a processing circuit to add the pixel values for each pixel of the macroblock according to each of the one or more additional predefined patterns comprises processor-executable programming for causing a processing circuit to add the respective group value for each of the plurality of pixel groups of the macroblock according to each of the one or more additional predefined patterns.

24. The processor-readable storage medium of claim 21, further comprising processor-executable programming for causing a processing circuit to:
encode the macroblock based at least in part on whether the macroblock is determined to include or not include at least one of text or computer generated graphics.

25. The processor-readable storage medium of claim 24, wherein the processor-executable programming for causing a processing circuit to encode the macroblock based at least in part on whether the macroblock is determined to include or not include at least one of text or computer generated graphics comprises processor-executable programming for causing a processing circuit to:
encode the macroblock utilizing a lower quantization parameter when the macroblock is determined to include at least one of text or computer generated graphics; and
encode the macroblock utilizing a higher quantization parameter when the macroblock is determined to not include at least one of text or computer generated graphics.

26. The processor-readable storage medium of claim 21, wherein the macroblock is 16 pixels by 16 pixels in size.

27. The processor-readable storage medium of claim 21, further comprising processor-executable programming for causing a processing circuit to obtain the digital image.
